(19) United States
(12) Patent Application Publication
(10) Pub. No.: US 2005/0283341 A1
(43) Pub. Date: Dec. 22, 2005

(54) Method and device for detecting wear in control units

(76) Inventors: Klaus Dressler, Loechgau (DE); Stephan Wohlfahrt, Stuttgart (DE)

Correspondence Address: KENYON & KENYON, ONE BROADWAY, NEW YORK, NY, 10004, US

(21) Appl. No.: 10/996,485

(22) Filed: Nov. 24, 2004

(30) Foreign Application Priority Data
Dec. 19, 2003 (DE) 10360892.3

(51) Int. Cl. G06F 11/30

(52) U.S. Cl. 702/185

(57) ABSTRACT

A method and a device for detecting wear in control units for controlling operating sequences in a vehicle, as well as a corresponding control unit, a variable representing the wear of a charge-coupled memory of the control unit is evaluated for the detection of wear of the control unit.

### FIELD OF THE INVENTION

The present invention starts from a method and a device for the detection of wear in control units as well as a corresponding control unit for controlling operational sequences in a motor vehicle.

### BACKGROUND INFORMATION

In this vein, German Patent Application No. DE 195 16 481 shows a device for detecting, storing and outputting data of a control unit in a motor vehicle. In this context, essential data of the life history, and, among other things, also the temperature of the control unit are to be recorded, stored and output when necessary, and consequently to give clues as to the probability of failure and reliability for judging a control unit that is in use. This is done since control units of motor vehicles represent a considerable cost factor, and the operation of a motor vehicle, which is rough per se, has the result that mechanical, electrical and thermal influences from outside represent a certain danger potential for a control unit. In this context, measured values are taken which lie above and below certain limits. Using these maximum and minimum temperatures, data with respect to the probability of failure and to reliability of the control unit are possible which, however, have a certain lack of accuracy.

Therefore, it is an object of the present invention to provide a more accurate and reliable method with respect to the related art, which makes possible the detection of wear in control units for controlling operational sequences in a vehicle.

### SUMMARY OF THE INVENTION

To do this, we start from a method and a device for detecting wear in control units, as well as from a corresponding control unit for controlling operating sequences in a motor vehicle, advantageously one variable representing the wear of the charge-coupled memory of the control unit for detecting wear being evaluated itself.

With that, by contrast to the related art, in which only the maximum or minimum temperature is recorded, a continuous statement with respect to the control unit is possible, concerning the wear up to a certain point in time, and an estimation of the utilization period or service life that is still possible from a point in time.

In this context, in an advantageous manner, the variable representing the wear of the charge-coupled memory either corresponds to a temperature of the charge-coupled memory, or to a variable that changes with the temperature of the charge-coupled memory, or to the frequency of an alternating voltage using which the charge-coupled memory and at least parts of the control unit are being operated. Preferred, in this context, is a variable from which one may ascertain a loss in dielectric medium of the charge-coupled memory, in particular, the temperature.

In this context, the charge-coupled memory expediently forms one constructional unit with the control unit, or is integrated into it. As far as the charge-coupled memory itself is concerned, advantageously, a capacitor is involved, especially an electrolytic capacitor, or even a battery, the concept battery summarizing all components related to this, such as galvanic elements, normal elements, accumulators and even batteries.

The wear detection according to the present invention thus makes possible at any time a statement concerning the service life already used up or the utilization period of the control unit, and, by extrapolation, especially at a constant load profile, the theoretically expected end to the service life or utilization period is able to be estimated.

### BRIEF DESCRIPTION OF THE DRAWINGS

FIG. 1 shows a control unit having an integrated charge-coupled memory.

FIGS. 2 and 3 show a control unit in which the control unit and the charge-coupled memory form a constructional unit, in FIG. 3 there being no direct contact between charge-coupled memory and control unit.

### DETAILED DESCRIPTION

According to the present invention, the utilization period of electronic control units is determined essentially by the service life of the charge-coupled memories used in them, such as, for instance, capacitors, especially electrolyte capacitors or aluminum electrolyte capacitors, so-called Al-elkos or even batteries. According to the present invention, these charge-coupled memories represent the weakest link of the utilization chain, since these charge-coupled memories, especially these capacitors or electrolyte capacitors are just those components which are the most, if not the only ones, subject to substantial wear. This wear is caused by the fact that the contained and function-relevant electrolyte or dielectric medium, respectively, or the equivalent in a battery disappear with time and as a function of certain conditions. The effect is greater the higher certain boundary conditions are, especially a variable representing particularly the wear of the charge-coupled memory, such as temperature, electrical charge, frequency in alternating voltage operation of the charge-coupled memory, and thus lead to wear and particularly to the disappearance of the electrolyte or the dielectric medium. In one preferred embodiment, in this context, the temperature is evaluated which results on its part, in turn, from the environmental temperature, the component heating, such as by an alternating current load, just as the self-heating of the charge-coupled memory. In a preferred manner, the temperature of the charge-coupled memory thus represents a central physical variable, as a function also of other variables such as the charge, the frequency in the case of alternating voltage operation, with the aid of which the wear of the charge-coupled memory and therewith its used-up utilization period and thus also the used-up utilization period of the control unit is able to be detected.

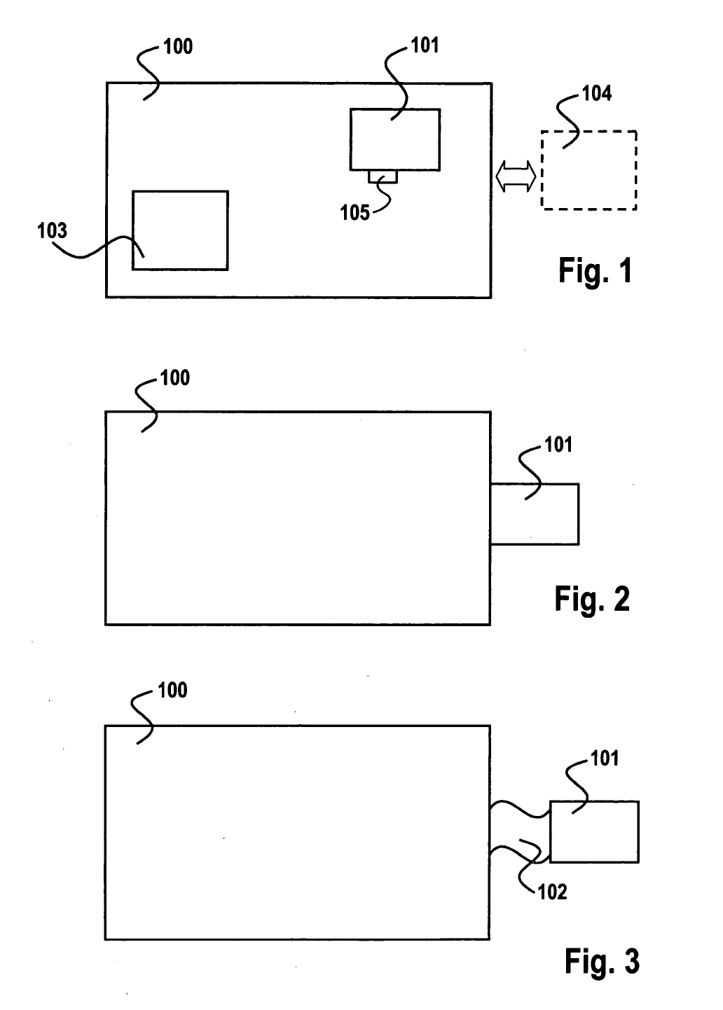

In this context, it should be noted that the charge-coupled memory does not fail abruptly at the specified end of the service life or utilization period, but that certain parameters of the charge-coupled memory are no longer being maintained exactly or at all, such as, for example, a substitute series resistance or even a capacitance. On this point, FIG. 1 shows a device having a control unit 100 and a charge-coupled memory 101 integrated into it, as well as an evaluation unit 103. Evaluation unit 103 in FIG. 1, according to the present invention, is, for example, integrated into control unit 100 and makes possible a sort of on-board detection or on-board diagnosis with respect to the service life or utilization period respectively of the control unit. In the same way, the evaluation unit may only be able to be connected outside the control unit in the vehicle itself, or even outside the vehicle, to the control unit, as shown here by 104. However, in that case, an at least slimmed down evaluation unit should be present, just as 103 is here, in the vehicle or in the control unit, if a continuous evaluation and detection is preferably desired, as according to the present invention. This means that in the case of returns or field test units, not only can the number of operating hours be read out, as up to the present, but a clear statement can also be made on the real load on the unit up to the time of testing. The information gathered from this may, in turn, find its way into new developments, and one may thus achieve a custom-made design. Thus over-dimensioning would be excluded.

The vehicle manufacturer thereby also obtains an understanding in the field, particularly under test conditions, with respect to the loading of the units. Thereby it would be possible to judge whether, for instance, a fuel heat sink is required or how this should be designed, if, as the control unit, an engine control unit is involved. However, besides for engine control units, an estimation may also be made with respect to all other control units present in the vehicle, such as for the brakes, the transmission, etc. With that, clear statements on the wear may be made in customer service situations. It would then also be possible, already during inspection, to point out to the vehicle's owner that he might consider replacing the control unit, whereby unexpected failures and downtime may be avoided. This also applies to the case corresponding to FIG. 2, where control unit 100 and charge-coupled memory 101 are one constructional unit, that is, charge-coupled memory 101 is not integrated into the control unit, but is only in direct contact with the control unit. For reasons of clarity, evaluation unit 103 or an optional external evaluation unit 104 are not shown in FIGS. 2 and 3, but are, of course, there (at least 103, and 104 optionally).

FIG. 3 also shows a constructional unit according to the present invention between control unit 100 and charge-coupled memory 101, which, however, in contrast to FIG. 2, has no direct contact, but rather, works with the aid of connecting element 102, such as a flexible conductor foil, a rigid contact connection or even an especially heat-conducting connection between control unit and charge-coupled memory without electrical contact, the electrical contact being produced in a different manner by a line or something similar. Consequently, the constructional unit in FIG. 3 requires a great spatial proximity, without, however, direct contact corresponding to FIG. 2, to make possible the capability of giving information of the method according to the present invention.

According to the present invention, in this context, charge-coupled memories in the form of capacitors are preferred, and, in this particular context, electrolyte capacitors are in turn preferred, which is why in the exemplary embodiment we speak of electrolyte capacitors or elkos. However, as stated before, this is not to be valued restrictively with regard to the subject matter according to the present invention.

According to the present invention, one first records a temperature of the electrolyte capacitor, such as the surface temperature. This recording is made using a suitable temperature sensor, such as a PTC resistor or an NTC resistor or the like, as shown by 105 in FIG. 1. In this context, especially with PTC resistors or NTC resistors, possible nonlinearities are able to be corrected by software. Furthermore, an analog to digital conversion then takes place, for example, in a processing unit, such as a microcontroller, especially in the execution unit or evaluation unit 103. In this context, the conversion and the recording may take place in a slow slice of time of the software, that is, in a slow cycle.

For the evaluation of the wear, that is, the variables representing the wear, especially the temperature, the following formula EQ1 may be used:

$${L}_{x} = {L}_{0} \cdot 2 \frac{{T}_{0} - ( {T}_{u} + Δ T )}{10} \qquad EQ1$$

In this context, L_{X} corresponds to the calculated service life or utilization duration for the environmental temperature Tᵤ of the electrolyte capacitor. L₀ corresponds to the service life for the upper category temperature, since the service life of charge-coupled memories, especially of electrolyte capacitors or aluminum electrolyte capacitors (Al elkos) as a rule are given on the data sheet of the manufacturer at an upper category temperature, for instance, 3000 hours at +125° C. Thus, using the formula given, one may recalculate for other temperatures. Consequently, L₀ is equivalent to the service life for the upper category temperature, just, for example, 3000 hours and T0 of the upper category temperature itself, just, for example, 125° C. In this context, ΔT shows the difference between an environmental temperature T_{outside} and a capacitor inside temperature T_{K}. In this context, the inside temperature of the capacitor is very difficult to record, from a measuring technology point of view, and is replaced, according to the present invention, by the surface temperature with the addition of a correction factor. Since the outer thermal resistance between the surface and the surroundings is many times greater than between the surface and the core, the error created in this context remains small because of this approximation.

The software of evaluation unit 103 now records, in the cycle of the time slice, that is, for example, every second, the surface temperature of the electrolyte capacitor, particularly of the aluminum electrolyte capacitor, and recalculates this temperature, using the formula given, to yield the wear duration at the corresponding reference temperature. By summing these values, it is possible, for instance, to output a statement of the percentage of the wear so far. This will be explained below in the light of an example:

Let us say that, according to the data sheet, the service life of the aluminum electrolyte capacitor is, for instance, 3000 hours at +125° C. With the aid of formula GL1, this yields the following values:
10 sec. at +75° C. corresponds to 0.313 sec. at +125° C.
10 sec. at +85° C. corresponds to 0.625 sec. at +125° C.
10 sec. at +95° C. corresponds to 1.250 sec. at +125° C.

Thus a
30 sec. measurement corresponds to 2.188 sec. at +125° C.
   That would, then, use up 2.188 sec. of 10.8 million sec., which is equivalent to 3000 hours. After a longer measurement, a percentage statement is meaningful. From this, the wear, and from that the utilization duration of the charge-coupled memory may be ascertained, and one may conclude from this a second utilization duration of the control unit itself, since upon failure of the weakest link in the chain, that is the electrolyte capacitor, the control unit fails too.

This makes possible a constant ascertainment of the wear duration up to the present, and therewith makes an estimate of the utilization duration still to be expected very reliable and accurate, particularly compared to the related art.

1. A method for detecting wear in control units for controlling operating sequences in a vehicle, the method comprising:
evaluating a variable representing the wear of a charge-coupled memory of a control unit for the detection of wear of the control unit.

2. The method according to claim 1, wherein the variable representing the wear of the charge-coupled memory corresponds to a temperature of the charge-coupled memory.

3. The method according to claim 1, wherein the variable representing the wear of the charge-coupled memory corresponds to an electrical charge of the charge-coupled memory.

4. The method according to claim 1, wherein the variable representing the wear of the charge-coupled memory corresponds to a variable that changes with a temperature of the charge-coupled memory.

5. The method according to claim 1, wherein the variable representing the wear of the charge-coupled memory corresponds to a frequency of an alternating voltage.

6. The method according to claim 1, further comprising, in the light of the detection of the wear, ascertaining a first service life of the charge-coupled memory and from that ascertaining a second service life of the control unit.

7. The method according to claim 1, further comprising ascertaining a loss of dielectric medium as a function of the variable representing the wear of the charge-coupled memory.

8. A device for detecting wear in control units for controlling operating sequences in a vehicle, comprising:
means for evaluating a variable representing the wear of a charge-coupled memory of a control unit for the detection of wear of the control unit.

9. The device according to claim 8, wherein the charge-coupled memory is situated in the control unit.

10. The device according to claim 8, wherein the charge-coupled memory forms a constructional unit with the control unit.

11. The device according to claim 8, wherein the charge-coupled memory is a capacitor in the control unit.

12. The device according to claim 11, wherein the capacitor is an electrolyte capacitor.

13. The device according to claim 8, wherein the charge-coupled memory is a battery in the control unit.

14. A control unit comprising:
a device for detecting wear for controlling operating sequences in a vehicle, the device including means for evaluating a variable representing the wear of a charge-coupled memory of the control unit for the detection of wear of the control unit.
